(19) United States
(12) Patent Application Publication
(10) Pub. No.: US 2006/0046175 A1
(43) Pub. Date: Mar. 2, 2006

(54) Toner for electrostatic latent image development and image forming method

(75) Inventors: Eiichi Yoshida, Tokyo (JP); Asao Matsushima, Tokyo (JP); Ken Ohmura, Tokyo (JP); Hiroshi Yamazaki, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Holdings, Inc., Tokyo (JP)

(21) Appl. No.: 10/925,632

(22) Filed: Aug. 25, 2004

(51) Int. Cl. G03G 9/08

(52) U.S. Cl. 430/108.7; 430/137.14; 430/111.4; 430/110.3; 430/108.6

(57) ABSTRACT

A toner for electrostatic latent image development, in which the image quality is fine, toner blister would not occur, and furthermore, the image quality which can fulfill customer's satisfaction can be obtained regardless of the temperature humidity environment in the image forming. The toner for electrostatic latent image development is made by agglomeration of resin particles and colorant particles in an aqueous medium. The acid value of the toner is less than 20 mgKOH/g, and the hydroxyl value of the toner is 7 to 57 mgKOH/g.

### BACKGROUND

1. Technical Field

This is related to a toner for electrostatic latent image development, and also is related to an image forming method by the use thereof.

2. Description of the Related Art

The main stream of image forming by electrophotography has shifted to a digital method. In an image forming by digital method, superior reproducibility of micro line and high resolution are required in order to manifest a small dot at 1200 dpi (the number of dots per 2.54 cm) level. In order to attain them in electrophotography, it is essential to use a toner for electrostatic latent image development having small diameter.

As for the manufacturing method of such toner having small diameter, JP Tokukai 2002-296839A and JP Tokukai 2002-351140A disclose a manufacturing method of toner in which toner material such as polyester resin is emulsified and dispersed in an aqueous medium, and resin particles in the emulsified dispersions are agglomerated to be particles of toner size.

However, the toner manufactured by the above-described method adsorbs a large amount of water. Thus, the image has a defect of white spot due to the vapor generated from the inside of the toner at heat-fixing. Hereinafter, this defect is referred to as “toner blister”.

On the other hand, as for the embodiment of the above-described digital image forming, an application to print on demand field in which a printing is carried out “only when needed, and only necessary number of copies” can be given. When an electrophotography is applied to this field, it is not required that a printing plate which is performed in printing of earlier development, is formed, and it is possible to publish several hundreds copies of press and to make direct mails or invitations while changing the addresses thereof. Thus, it attracts attention as a possible image forming means which is alternative to light printing.

However, when the image forming by electrophotography is employed, it has become obvious that the method has a problem in making mail matters and invitations while changing the address thereof as described above. That is, when the image forming is performed on a thick paper such as an invitation card to wedding, a postcard for telling in mourning and a thank-you letter for attending funeral, it is impossible to obtain sufficient fixing property. In particular, it has found that a postcard for telling in mourning and a thank-you letter for attending funeral with which a gray frame is provided easily have poor fixing property at the gray frame part. Furthermore, the poor fixing property can cause dirt of user's hands by unfixed toner and contamination of paper.

As is often seen, commuters read a paperback with their one hand while hanging onto a strap in the rush. It is required that a bound printed matter has a “slipping property” that a user can flip with his one hand a page in such condition and “fixing property” that paper and letter are not contaminated by rubbing a toner. However, a toner image by electrophotography compares unfavorably with a general printed matter in terms of slipping property and fixing property.

Further, an electrophotograph does not always fulfill the customer's requirement sufficiently in terms of the image quality and stability thereof. Thus, problems remain before an electrophtograph becomes common as an image forming means of print on demand field. The above problems do not resolved even when the toners disclosed in JP Tokukai 2002-296839A and JP Tokukai 2002-351140A are used. Therefore, it has not accepted in print industry that an electrophotograph is applied to an image forming of print on demand field.

### SUMMARY

This is to solve the above problems.

The first problem to be solved is to provide a toner for electrostatic latent image development, in which the image quality is fine, toner blister does not occur, and furthermore, the image quality which can fulfill customer's satisfaction can be obtained regardless of the temperature humidity environment normally used in the image forming, and an image forming method by the use thereof.

The second problem to be solved is to provide a toner in which the toner image formed on a printing sheet can have a slipping property and fixing property comparable to a printed matter in earlier development.

According to the first aspect, a toner for electrostatic latent image development has a acid value of less than 20 mgKOH/g and a hydroxyl value of 7 to 57 mgKOH/g, wherein the toner is made by agglomeration of resin particles and colorant particles in an aqueous medium.

According to the second aspect, an image forming method comprises developing a latent image of a photoconductor by using the toner of the first aspect.

According to the third aspect, a toner for electrostatic latent image development is made by agglomeration of resin particles having an acid value of less than 20 mgKOH/g and a hydroxyl value of 7 to 57 mgKOH/g and lubricant particles having an acid value of less than 5 mgKOH/g in an aqueous medium.

According to the fourth aspect, an image forming method comprises developing a latent image of a photoconductor by using the toner of the first aspect.

According to the toner of the first and third aspects and the image forming method of the second and fourth aspect, it becomes possible that fine image quality is obtained where toner blister does not occur, and furthermore, it can fulfill customer's satisfaction regardless of the temperature humidity environment in the image forming. Further, it becomes possible that the toner image formed on a printing sheet have a slipping property and fixing property comparable to a printed matter in earlier development.

### BRIEF DESCRIPTION OF THE DRAWINGS

The present invention will become more fully understood from the detailed description given hereinbelow and the appended drawings. However the drawings are simply intended as an explanation and thus does not limit the scope of the present invention, and wherein;

FIG. 1 is a constitution view showing one of example of an image forming apparatus,

FIG. 2 is a constitutional section view showing an digital image forming apparatus, and

FIG. 3 is a section view showing one of examples of a fixing device.

### DETAILED DESCRIPTION OF THE PREFERRED EMBODIMENT

Hereinafter, the embodiments will be explained. In the following description, a definition of word is described. However, it only explains the definition of word in the embodiment, thus the definition of word in the invention is not limited thereto.

[Toner]

A toner of the embodiment is made by agglomeration of liquid particles in an aqueous medium. The toner obtained by the agglomeration has the acid value of less than 20 mgKOH/g and the hydroxyl value of 7 to 57 mgKOH/g.

An acid value represents mg amount of potassium hydrate needed for neutralizing free fatty acid contained in 1 g of resin and the like. A sample are dissolved into benzene-ethanol mixed solvent and the like, and the solution is titrated with potassium hydrate solution having accurately known titer, and the acid value is calculated from the amount needed to be neutralized.

The hydroxyl value represents mg amount of potassium hydrate needed for neutralizing acetic acids bound to acetylide contained in 1 g of resin and the like.

The acid value and hydroxyl value can be regulated not only by controlling a ratio an acid component to an alcohol component in a synthesis process but also by changing a condition of synthesis reaction. They will be hereinafter described.

The liquid particle is solution where a binder resin, a colorant, a lubricant and the like are dissolved into organic solvent. The dispersions before agglomeration can be a mixture of dispersions where the binder resin particles (a solution where the binder resin is dissolved to organic solvent) are dispersed to an aqueous medium (the acid value and hydroxyl value of the binder resin is less than 20 mgKOH/g and 7 to 57 mgKOH/g respectively), a dispersions where the colorant particles are dispersed to an aqueous medium, and a dispersions where the lubricant particles are dispersed to an aqueous medium (the acid value of the lubricant is less than 5 mgKOH/g); or dispersions where the mixture solution in which the binder resin, colorant and lubricant are dissolved to organic solvent is dispersed to an aqueous medium. Hereinafter, the toner will be described in detail.

[Chemical Compounds Used in Manufacturing Toner]

The compounds used as the toner materials are (1) binder resin, (2) colorant, (3) lubricant, (4) charge controlling agent, and (5) external additive.

(1) Binder Resin

A binder resin is a component of the toner. The binder resin possibly has an acid value of 20 mgKOH/g, and a hydroxyl value of 7 to 57 mgKOH/g. As for a binder resin, any resins can be given as long as they are obtained by polyaddtion or polycondensation reaction and they can form dispersions of the resin particles in an aqueous medium. For example, amorphous polyester resin or polyol resin can be given as the representative. Amorphous polyester resin is more preferable.

The amorphous polyester resin will be explained.

Here, “amorphous” of the amorphous polyester resin designates a condition that polyester molecules in which any clear crystalline structures are not found in X ray diffractrometry occupy 50% or more of the whole constituent molecules. For more detail, a compound in which molecules having the crystallinity thereof of less than 0.1 occupy 50% or more is denoted as the amorphous polyester.

The crystallinity used in this description is measured by density, heat of fusion, X ray diffractrometry and NMR (nuclear magnetic resonance spectrum), and represents mass ratio (percentage) of crystalline region.

As for the polyvalence carboxylic acid used for the amorphous polyester resin, for example, terephthalic acid, isophthalic acid, orthochromatic phthalic acid, 1,5-naphthalene dicarboxylic acid, 2,6-naphthalene dicarboxylic acid, diphenic acid, sulfo terephthalic acid, 5-sulfo isophthalic acid, 4-sulfo phthalic acid, 4-sulfo naphthalene-2,7-dicarboxylic acid, and 5-[4-sulfo phenoxy]isophthalic acid, Sulfo terephthalic acid, and/or those metal salt, aromatic dicarboxylic acid such as ammonium salt, aromatic oxycarboxylic acid such as hydroxy-benzoic-acid p-(hydroxy ethoxy)benzoic acid, aliphatic dicarboxylic acid such as succinic acid, adipic acid, azelaic acid, sebacic acid, and dodecane dicarboxylic acid, unsaturated fat group such as fumaric acid, maleic acid, itaconic acid, hexahydrophthalic acid, tetrahydrophthalic acid, alicyclic dicarboxylic acid, and the like can be given as examples. Further, trivalent or more carboxylic acid such as trimellitic acid, trimesic acid and pyromellitic acid also can be given as examples.

As for the polyhydric alcohols used for amorphous polyester resin, multivalent aliphatic alcohols, multivalent alicyclic alcohols, multivalent aromatic alcohols and the like can given as examples. As for the multivalent aliphatic alcohols, aliphatic diols such as ethylene glycol, propylene glycol, 1,3-propanediol, 2,3-buthandiol, 1,4-butanediol, 1,5-pentanediol, 1,6-hexanediol, neopentyl glycol, diethylene glycol, dipropylene glycol, 2,2,4-trymethyl-1,3-pentanediol, polyethylene glycol, polypropylene glycol, and polytetramethylene glycol, and triols and tetraols such as trimethyol ethane, trimethyol propane, glycerin, and pentaerythritol can be given as examples. As for the alicyclic polyvalent alcohols, 1,4-cyclohexane diol, 1,4-cyclohexane dimethanol, spiro glycol, bisphenol hydroxide A, propylene oxide adduct of and ethyleneoxide adduct of bisphenol hydroxide A, tricyclodecanediol, tricyclodecane dimethanol and the like can given as examples.

As for the multivalent aromatic alcohols, paraxylene glycol, meta-xylene glycol, orthoxylene glycol, 1,4-phenylene glycol, ethyleneoxide adduct of 1,4-phenylene glycol, bisphenol A, ethyleneoxide adduct of bisphenol A, propylene oxide adduct and the like can be given as examples. Furthermore, as for the polyesterpolyol, lactone system polyester polyols obtained by ring opening polymerization of the lactones such as ε-caprolactone, as polyester polyol can be given as examples.

As for the method to obtain low oxidized resin, the following method can be given as one of examples. That is, in order to block a polar group located at the terminals of polyester polymer, it is preferable to introduce a monofunctional monomer to the polyester.

As for the monofunctional monomers, benzoic acid, chlorobenzoic acid, bromobenzoic acid, p-hydroxybenzoic acid, mono-ammonium sulfobenzoate, monosodium sulfobenzoate, cyclohexyl amino carbonyl benzoic acid, n-dodecyl amino carbonyl benzoic acid, t-butyl benzoic acid, naphthalene carboxylic acid, 4-methylbenzoic acid, 3-methylbenzoic acid, salicylic acid, thiosalicylic acid, phenylacetic acid, acetic acid, propionic acid, butyric acid, isobutyric acid, octane carboxylic acid, lauryl acid, and stearyl acid, monocarboxylic acids such as their lower alkyl ester, and monoalcohols such as aliphatic alcohols, aromatic alcohols and alicyclic alcohols can be used.

The polyester resin used in manufacturing this toner can be one called urethane denatured polyester, which is denatured to have an urethane linkage in the molecular structure thereof.

The polyester resin can be manufactured, for example, by polycondensation of multivalent alcohol component and multivalent carboxylic component by using an esterification catalyst under inert gas atmosphere at a temperature of 180 to 250° C.

The polyester resin can be manufactured by a method comprising a process of an ester exchange reaction of at least dicarboxylic acid component, diol component and one or more compound selected from the group consisting of tri- or more multivalent carboxylic acid component and tri- or more multivalent alcohol component, and a process to cross-link the polymer formed by a removal of the formed diol component out to the reaction system together with polymerizing the ester obtained in the ester forming process under vacuum condition of 150 mmHg or less and presence of polycondensation catalyst.

Preferably, a toner having superior non-offset property can be obtained by using a cross-linked type polyester as the binder which is obtained by the process that etherificated bisphenol A and dicarboxylic acid component are reacted with each other so as to obtain linear polyester, and a monomer component having the valency thereof of 3 or more such as trimellitic acid anhydride are added to the linear polyester to form a cross-linked structure.

In order that the toner has the acid value of less than 20 mgKOH/g and the hydroxyl value of 7 to 57 mgKOH/g, the acid value of the polyester is regulated in the synthesis process of the polyester resin. The acid value of the polyester resin can be regulated by methods of (1) changing a composition ratio of the acid component and the diol component, and (2) changing a reaction ratio of the esterification reaction and/or the ester changing reaction. According to the above method (1), the more the amount of the acid component are and the less the amount of lower alkyl ester of acid, the higher the acid value of the obtained polyester resin can be. According to the above method (2), the lower the reaction ratio is, the higher the acid value of the obtained polyester is.

The polyol resin will be explained.

Various types of polyol resin can be used, and the following are preferable for manufacturing a toner.

As for the polyol resin, it is preferable to use the polyol made by a reaction of epoxy resin, alkylene oxide adduct of dihydric phenol or the glycidyl ether thereof, a compound having one active hydrogen reacting with epoxy resin, and a compound having two active hydrogen reacting with epoxy resin. The epoxy resin consists of preferably two or more bisphenol A type epoxy resins having different number average molecular weight each other. This polyol resin gives fine glossiness and transparency and is effective in improving offset resistance property.

The epoxy resin is preferably obtained by binding bisphenol such as bisphenol A and bisphenol F with epychlorohydrin. The epoxy resin consists of two or more types of bisphenol A type epoxy resin, having different number average molecular weight each other in order to obtain stable fixing property and glossiness, where the number average molecular weight of the lower molecular weight component is preferably 360 to 2000, and the number average molecular weight of the higher molecular weight component is preferably 3000 to 10000. Further, it is preferable that the lower molecular weight component occupies 20 to 50 mass %, and the higher molecular weight component occupies preferably 5 to 40 mass %. When the lower molecular weight component is too much or the molecular weight thereof is less than 360, there is a possibility to cause too much glossiness, and furthermore, degradation of its shelf life. When the higher molecular weight component is too much or the molecular weight thereof is more than 10000, there is a possibility to cause lack of glossiness, and furthermore, degradation of fixing property.

As for the alkylene oxide adducts of bihydric phenols, the following can be given as examples. Ethylene oxide, propylene oxide, butylene oxide and the reaction products of their mixture and bisphenol such as bisphenol A and bisphenol F can be given. The obtained adducts can be glycidylated with epichlorohydrin or β-methyl epichlorohydrin. In particular, diglycidyl ether of alkylene oxide adduct of bisphenol A represented by the following formula (VI) is preferable.

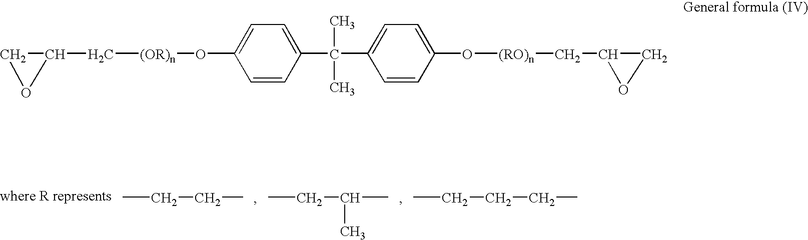

Further, where n and m are the number of repeating unit, each of them are 1 or more respectively, and n+m=2 to 6.

It is preferable that alkylene oxide adduct of bihydric phenol or the glycidyl ether thereof is contained 10 to 40 mass % with respect to the polyol resin.

Here, when the content is small, defects such as increase of curl occur. When n+m is 7 or more or the content is too much, there is a possibility to cause too much glossiness, and furthermore, degradation of its shelf life. As for the compound having one active hydrogen reacting with epoxy resin, monohydric phenols, secondary amines, carboxylic acids and the like can be given.

As for the monohydric phenols, the following can be given as examples. That is, phenol, cresol, isopropyl phenol, aminophenol, nonylphenol, dodecylphenol, xylenol, p-cumylphenol, and the like can be given. As for the secondary amines, diethylamine, dipropylamine, dibutylamine, N-methyl(ethyl)piperazine, piperidine, and the like can be given. Further, as for the carboxylic acids, propionic acid, caproic acid, and the like can be given.

In order to obtain the polyol resin having epoxy resin part and alkylene oxide part in the main chain thereof, various combinations of materials can be applied. For example, it can be obtained by reacting epoxy resin having glycidyl groups at the both terminals thereof and alkylene oxide adduct of bihydric phenol having glycidyl groups at the both terminals thereof with dihalide, di-isocyanate, diamine, dithiol, multihydric phenol or dicarboxylic acid. Among them, bihydric phenol is the most preferable in a viewpoint of reaction stability. Further, combination usage of multihydric phenols and multivalent carboxylic acids with bihydric phenol is also preferable. Here, the amount of the multihydric phenol and multivalent carboxylic acid is 15 mass % or less with respect to the whole amount, preferably 10% or less.

As for the compound used in the invention, which has two or more active hydrogen reacting to epoxy group in the molecule, bihydric phenols, polyhydric phenols, and polyvalence carboxylic acids can be given. As for the bihydric phenols, bisphenol such as bisphenol A and bisphenol F can be given. As for the polyhydric phenols, orthochromatic cresol novolaks, phenol novolaks, Tris(4-hydroxy phenyl)methane, and 1-[alpha-methyl-alpha-(4-hydroxy phenyl)ethyl]benzene are given as examples. As for the polyvalence carboxylic acids, malonic acid, succinic acid, glutaric acid, adipic acid, maleic acid, fumaric acid, phthalic acid, terephthalic acid, trimellitic acid, and trimellitic anhydride are given as examples. It becomes difficult to let their polyester resin and polyol resin have transparency and glossiness, when they have high crosslink density. Thus, non-crosslinkage or low crosslinkage (insoluble matter for THF is 5% or less) is preferable.

(2) Colorant

As for the colorant used for the toner, all dyes and pigments in the public can be used. Concretely, carbon black, Nigrosine dye, iron black, naphthol yellow S, Hansa yellow (10G, 5G, G), cadmium yellow, synthetic ochre, ocher, chrome yellow, titanium yellow, polyazo yellow, oil yellow, Hansa yellow (GR, A, RN, R), pigment yellow L, benzidine yellow (G, GR), permanent yellow (NCG), vulcan fast yellow (5G, R), tartrazine lake, quinoline yellow lake, anthrazan yellow BGL, isoindolinone yellow, red ocher, minium, vermilion lead, cadmium red, cadmium mercury red, antimony vermilion, permanent red 4R, para red, red, p-chloro o-nitroaniline red, lithol fast Scarlet G, brilliant fast scarlet, brilliant carmine BS, permanent red (F2 R and F4 R, FRL, FRLL, F4RH), fast scarlet VD, vulcan fast rubine B, brilliant scarlet G, lithol rubine GX, permanent red F5R, brilliant carmin 6B, pigment schalet 3B, Bordeaux 5B, toluidine maroon, and permanent Bordeaux F2K, helio Bordeaux BL, Bordeaux 10B, a BON maroon light, a BON maroon medium, eosine lake, rhodamine lake B, rhodamine lake Y, alizarin lake, thioindigo red B, thioindigo maroon, oil red, quinacridone red, pyrazolone red, polyazo red, chromium vermilion, benzidine orange, perynone orange, oil orange, cobalt blue, cerulean blue, alkali blue lake, peacock blue lake, Victoria blue lake, non-metal copper phthalocyanine blue, copper phthalocyanine blue, fast sky blue, indanthrene blue (RS, BC), indigo, ultramarine blue, Berlin blue, anthraquinone blue, fast violet B, violet lake, cobalt violet, manganese violet, dioxane violet, anthraquinone violet, chrome green, zinc green, chrome oxide, viridian, emerald green, pigment green B, the naphthol green B, green gold, acid green lake, Malachite green lake, phthalocyanine green, anthraquinone green, titanium oxide, zinc white, lithopone and the mixture thereof can be used.

The amount used is generally 1 to 20 parts by mass with respect to 100 parts by mass of the binder resin.

(3) Lubricant (Wax)

It is preferable that a lubricant is contained in the toner in order to give a proper release property to the developer. It is preferable that the lubricant has the melting point thereof of 40 to 120° C., in particular 50 to 110° C. Further, the lubricant has an acid value of less than 5 mgKOH/g.

It is confirmed that when the lubricant has the melting point thereof within the above range, a fine fixing property is obtained even when the fixing temperature is set low, and that a fine resistance to offset property and fine durability are obtained.

The melting point of the lubricant can be obtained by a differential scanning calorie measuring method (DSC). That is, the melting peak value in heating a sample of several mg at a constant temperature rising rate (10° C./min, for example) is denoted as the melting point.

As for the lubricant being capable of applied to manufacturing the toner, for example, solid paraffin wax, micro wax, rice wax, fatty amide system wax, fatty acid system wax, aliphatic monoketones, fatty acid metal salt system wax, fatty acid ester system wax, partial saponification fatty acid ester system wax, silicone varnish, higher alcohol, carnauba wax, and the like can be given.

Further, polyolefins such as low molecular weight polyethylene and polypropylene can be used. In particular, polyolefin having the softening point thereof of 70 to 150° C. measured by a ball and ring method is preferable, and polyolefin having the softening point thereof of 120° C. to 150° C. is more preferable.

Further, the ester compounds represented by the following general formula (2) can be given.
R₁—(OCO—R₂)ₙ General Formula (2)

(Where R₁ and R₂ represent hydrocarbon group of 1 to 40 carbon atoms which is capable of having a functional group respectively and n represents an integer of 1 to 4.)

(4) Charge Controlling Agent

The toner may contain a charge controlling agent according to need. As for the charge controlling agent, everything in the public can be used. For example, they are fluorine system activator, metal salicylate, metal salicylate derivative and the like. Concretely, bontron S-34 of azo system metallic complex compound, and E-82 of an oxy-naphthoic acid system metal complex, E-84 of salicylic acid system metal complex, E-89 of phenol system condensate (above, made by Orient Chemical Industries, Ltd), TP-302 and TP-415 of molybdenum complex of quaternary ammonium salt (above, made by Hodogaya Chemical Co., Ltd.), Copy Charge PSY VP2038 of quaternary ammonium salt, Copy Blue PR of triphenylmethane derivative, and Copy Charge NEGVP2036 and Copy Charge NX VP434 of quaternary ammonium salt (above, made by Hoechst A. G.), LRA-901, LR-147 of boron complex (made by Japan Carlit Co., Ltd.), copper phthalocyanine, perylene, quinacridone, azo pigments, and polymer compounds having a functional group such as sulfonic acid group, carboxyl group, quaternary ammonium salt can be given. Among them, azo system metal complex compound is preferable. For example, the compounds disclosed in 0009 to 0012 of JP Tokukai-2002-351150A are preferably used.

The amount of the charge controlling agent is decided according to the type of the binder resin, presence or absence of additives which is added according to need and the manufacturing method of the toner including the dispersion method. Though it can not be limited univocally, it is preferably used within a range of 0.1 to 20 parts by mass with respect to 100 parts by mass of the binder resin. The range is more preferably 0.2 to 5 parts by mass. When the amount is over 20 parts by mass, the effect of the main charge controlling agent is degraded since the electrostatic property of the toner is too high. Thus, the electrostatic attraction to the developer roller increases, which causes a decrease in the fluidity of the developer and a decrease in image density.

(5) External Additive

As for the external additive which supports the fluidity, developing property and electrostatic property of the obtained toner particles, inorganic fine particles can be preferably used. It is preferable that the inorganic fine particles have the average primary particle size thereof of 5 to 2000 nm, in particular 50 to 200 nm.

The ratio of surface to volume measured by a BET method is preferably 20 to 500 m²/g. The proportion of the inorganic fine particles is preferably 0.01 to 5 mass % of the toner, in particular 0.01 to 2.0 mass %.

As for the concrete example of the inorganic fine particles, silica, alumina, titanium oxide, barium titanate, magnesium titanate, calcium titanate, strontium titanate, zinc oxide, tin oxide, quartz sand, clay, mica, wollastonite, diatom earth, chrome oxide, cerium oxide, iron red, antimony trioxide, magnesium oxide, zirconium oxide, barium sulfate, barium carbonate, calcium carbonate, silicon carbide, silicon nitride, and the like can be given. Silica and titanium system micro particles are particularly preferable.

Further, polymer fine particles such as polystyrene obtained with soap free emulsion polymerization, suspension polymerization or dispersion polymerization, copolymer of methacrylate ester or acrylate ester, polymerized compound particles of polycondensed compounds such as silicone, benzoguanamine and nylon, and polymer particles of thermosetting resin can be given.

The above plasticizer can prevent the degradation of the fluidity and electrostatic property even when the surface is treated to be more hydrophobic or it is under a high humidity condition. As for the preferable surface treatment, for example, a silane coupling agent, a silyl agent, a silane coupling agent having an alkyl fluoride group, an organic titanate system coupling agent, an aluminum system coupling agent, silicone oil, denatured silicone oil and the like can be given.

As for the cleaning property improving agent to remove a residual developer left on a photo conductor and primary transferring medium after the transfer, for example, metal salts of aliphatic acid such as stearic acid, zinc stearate and calcium stearate, and polymer fine particles manufactured by a soap free emulsion polymerization or the like such as polymethyl methacrylate fine particles and polystylene fine particles can be given. It is preferable that the polymer fine particles have comparatively narrow range of the particle distribution thereof and the volume average particle size of 0.01 to 1 μm.

Here, an average size of a primary particles is obtained by a measuring method that the length of the inorganic fine particle located at the peripheral part of the toner particle is measured in a given one direction (for example, horizontal direction of the observed image) under an after-mentioned transmission electron microscope where and more than 200 particles are measured, and the arithmetical average size thereof is obtained. Concretely, when silica and titanium are used, an average size of silica and titanium are respectively obtained, and it is particularly preferable that either of them is 50 to 200 nm.

Hereinafter, a measuring method of average size of primary particles will be explained.

The toner containing inorganic fine particles is mounted on a grid mesh which is preferably coated with a carbon micro grid. The transmission image thereof can be observed under a transmission electron microscope (TEM), preferably a high resolution transmission electron microscope (HR-TEM), for example, a field-emission type transmission electron microscope (FE-TEM).

A composition of the inorganic fine particles can be identified by the following method.

The toner containing the inorganic fine particles is dispersed into purified water. The dispersions is dropped onto a grid mesh coated with a micro grid, so that a sample for observation is prepared.

Subsequently, the structure and composition are evaluated by using 200 kV field-emission type TEM “JEM-2010F” (made by JEOL Ltd.) and energy dispersive X-ray analyzer (EDS) “Voager” (made by Thermo Electron Corp.).

The measuring condition is set as follows:

| | |
|---|---|
| accelerating voltage | 200 kV |
| TEM image magnification range | 50,000 to 500,000 |
| EDS measuring period (live time) | 50 seconds |
| energy range to be measured | 0 to 2,000 |

[Method for Dispersing Resin Particles in Aqueous Medium]

A method for manufacturing the dispersions in which the binder resin particles are dispersed in an aqueous medium is not especially limited. The following methods can be given.

(1) In the case of polyaddition or polycondensation resin such as polyester resin and polyol resin, the following methods (a) and (b) are preferably used.

(a) A method that a precursor (monomer, oligomer and the like) or the solvent solution thereof is dispersed to an aqueous medium under a presence of a proper dispersant, subsequently it is cured by heating or adding a hardener, so that an aqueous dispersions of resin particles are manufactured.

(b) A method that an proper emulsifier is dissolved to a precursor (monomer, oligomer and the like) or the solvent solution thereof (preferably liquid, one liquefying by heat is possible), subsequently phase reversal of the emulsion is performed by adding water.

(2) In the case of vinyl system resin, a method that a monomer is used as a starting material, resin particles are formed by polymerization reaction such as suspension polymerization method, emulsion polymerization method, seed polymerization method, dispersion polymerization method or the like, so that the aqueous dispersions of the obtained resin particles is manufactured directly.

(3) A method that resin previously manufactured by polymerization reaction (any polymerization reaction such as polyaddition, polycondensation and the like can be possible) is dispersed to an aqueous medium by the following method (a) to (e).

(a) A method that the manufactured resin is grinded by using a pulverizer mill of mechanical rotation type, jet type or the like, and classified to obtain resin particles, subsequently they are dispersed to water under a presence of a proper dispersant.

(b) A method that the above-described manufactured resin is dissolved to solvent, the resin solution is sprayed to be in a form of mist so that resin particle are obtained, subsequently the resin particles are dispersed to water under a presence of a proper dispersant.

c) A method that a poor solvent is added to the resin solution in which the above-described manufactured resin is dissolved to solvent, or the resin solution where the resin is heated to be dissolved to solvent is cooled so that resin particles are deposited, subsequently the solvent is removed to obtain resin particles, and the obtained resin particles are dispersed to water under a presence of a proper dispersant.

(d) A method that the above-described manufactured resin is dissolved to solvent, the resin solution is dispersed to water under a presence of a proper dispersant, and subsequently the solvent is removed by heating, decompression or the like.

(e) A method that the above-described manufactured resin is dissolved to solvent, a proper emulsifier is dissolved to the resin solution, and subsequently water is added to perform phase reversal of emulsion.

As for the emulsifier and dispersant used in combination, known surfactants and water-soluble polymers and the like can be used. Further, solvent, a plasticizer and the like can be used in combination with them as an auxiliary agent of emulsification or dispersion. As for the concrete example, ones disclosed in 0036 to 0062 of JP Tokukai 2002-284881A can be given.

The colorant particles are dispersed in an aqueous medium together with the resin particles by the following methods (A) and (B).

(A) A method that a colorant is directly put into an aqueous medium containing a surfactant and a shearing treatment is given to disperse it.

(B) A method that a master batch which is kneaded with a kneaded mixture for toner or a resin is dissolved to solvent, subsequently the solution is put into an aqueous medium, so that emulsion of resin solution containing the colorant is prepared.

The above-described method (A) is disclosed, for example, in JP Tokukai 2000-292973A. That is, the colorant is dispersed to an aqueous medium containing a surfactant by an effect of shearing force generated by a screen forming compartments in a stirring room and a rotor rotating in the stirring room at high speed (furthermore, effects of collision force, pressure variation, cavitation, potential core).

The weight average particle size (dispersed particle size) is 30 to 500 nm, preferably 50 to 300 nm. When the weight average particle size is less than 30 nm, it becomes difficult to take them into the toner since they are remarkably suspended in the aqueous medium. On the other hand, when the weight average particle size is more than 500 nm, it becomes difficult to introduce them into the toner particles since the particles are not dispersed properly in an aqueous medium and easily precipitated. Further, free colorant is easily generated. The weight average size of the colorant particle is measured by electrophoresis light scattering photometer “ELS-800” (made by Otsuka Electronics Co., Ltd.).

The particle size distribution of the colorant particles is preferably 30 or less in the standard deviation thereof, more preferably 20 or less. When the particle size distribution of the colorant particles is 30 or less in the standard deviation thereof, the distribution can be sharp and the colorant particles can be certainly incorporated. Thus, it becomes that release of the colorant particle is hardly generated. The “particle size distribution of the colorant particles” designates a standard deviation measured by electrophoresis light scattering photometer “ELS-800” (made by Otsuka Electronics Co., Ltd).

The colorant particles used to obtain the toner are prepared by the process that the colorant is put into an aqueous medium containing a surfactant, and pre-dispersed (course-dispersed) with a propeller stirrer and the like so as to obtain pre-dispersions (dispersions of agglomerated particles of the colorant), and the pre-dispersions is put to a stirrer provided with a screen forming compartments in a stirring room and a rotor rotating in the stirring room at high speed and a dispersion treatment (fine dispersion treatment) is given by the stirrer.

As for the stirrer being capable of applied to the dispersion treatment to obtain the colorant particles, “Clearmix” (M-Technique Corp.) can be given. “Clearmix” comprises a rotor (a stirring propeller) which lets solution under process rotate at high speed and a screen (a fixed ring) which surrounds the rotor and is fixed and it has a structure to generate shearing force, coalition force, pressure variation, cavitation and potential core. Thus, emulsification and dispersion is performed by the multiplier effect of these effects. That is, “Clearmix” is used to form emulsion (to disperse liquid particles). However, the present inventors use the apparatus as a dispersing apparatus for dispersing the colorant particles (solid) to an aqueous medium. Thus, it becomes possible to obtain the dispersions of the colorant particles having suitable particle size and sharp particle size distribution In the above-described method (B), it is preferable that the materials are mixed mechanically to be homogenous before the dispersing process. That is, a mixing process is firstly required, where a toner composition containing at least a binder resin, a colorant master batch, and if necessary, charge controller and lubricant is mechanically mixed. This process is not especially limited and can be performed in a general condition by using a general mixer having a rotating screw and the like.

After the above mixing process is completed, the mixture is put into a kneader machine to be melted and kneaded. As for the kneader machine, a single or double-axis continuous kneader, a batch type kneader by roll mill can be used. For example, KTK type double-axis extruder made by Kobe Steel, Ltd., TEM type extruder made by Toshiba Corp., double-axis extruder made by K.C.K. Corp., PCM type double-axis extruder made by IKEGAI Corp., Ko-kneader made by Buss Corp. and the like are suitably used.

It is important that the melting and kneading process is carried out in a suitable condition in order not to cause a breakage of the molecule chain of the binder resin and overdispersion of the charge controller and lubricant. Concretely, the melting and kneading temperature should be decided with reference to the softening point of the binder resin and the melting temperature of the lubricant. When the temperature is excessively lower than the softening point, the breakage occurs markedly, and when it is excessively higher, the charge controller and lubricant are not dispersed.

When a master batch is used, it can be obtained by mixing and kneading a resin for master batch and a colorant with high shearing force. In this process, organic solvent can be used in order to enhance an interaction between the colorant and resin. Further, what is called flashing method that an aqueous paste including colorant and water is mixed and kneaded with a resin and organic solvent so that the colorant is moved to the resin phase and the moisture and organic solvent components are removed is preferably used, since a wet cake of a colorant can be used directly without a requirement of drying. A high shearing dispersion apparatus such as a triple roll mill is preferably used for the mixing and kneading.

In organic solvent, the obtained mixture or the master batch, resin or the other toner materials are stirred with a general impeller, subject to a heat treatment according to need, or dissolved and dispersed with a ball mill, a sand mill, a homogenizer and the like, so as to be emulsified and dispersed into an aqueous medium.

In this process, an emulsifying apparatus such as a homomixer (made by Tokusyu Kika Kogyo Co., Ltd.), Ebara Milder (made by Ebara Corp.), Clearmix (made by M-Technique Corp.) is used. It is possible to control the droplet diameter and particle size distribution to be desired values by regulating the concentration of the emulsifier, the concentration of the mixture with respect to the solvent, the mass ratio of solvent phase in which an aqueous medium and the mixture is dispersed, the rotation frequency and time in the emulsifying and dispersing and the like. It is preferable to perform the emulsifying and dispersing so that the size of the particles becomes ½ to 1/100 of a desired toner particle diameter. The mass ratio the mixture to the solvent and the mass ratio the aqueous medium to the solvent phase where the mixture is dispersed are properly selected from the ranges within 1:10 to 1:1 and 10:1 to 1:1 respectively. However it is also possible that they are out of these ranges.

As for the aqueous medium, alcohols such as methanol and ethanol, a part of which can be mixed with water or which can be diluted with water infinitely, can be given. Further, organic solvent such as ketones such as acetone can be used in combination with water.

As for the organic solvent for dissolving and dispersing the toner components of the mixture, it is not especially limited as long as it is insoluble, poorly soluble or partially soluble to water, and the resin constituting the mixture and the resin used in the kneading can be dissolved thereto. For example, toluene, xylene, methyl acetate, ethyl acetate, methyl ethyl ketone, methyl isobutyl ketone can be used solely or in combination of two or more. In particular, aromatic series solvent of toluene and xylene, and acetate ester are preferable.

As for the dispersant, which emulsifies and disperses the solvent phase, where the toner components are dispersed, to water-containing liquid so that the solvent phase has a desired particle size, anionic surfactant such as alkyl benzene sulfonate, α-olefin sulfonate and phosphate ester can be used.

As for the method to remove the inorganic solvent from the obtained emulsified dispersions, the method can be employed, where a whole system is gradually heated so that the inorganic solvent in the droplets are vaporized to be removed completely. It is preferable that this method is carried out under vacuumed condition since the heating temperature can be lowered. This is preferable because a wax and the other toner components are prevented from dissolving to the solvent, and emulsified dispersions are prevented from extraordinary agglomeration, association and fusion caused by heat. This removing process of inorganic solvent can be carried out either before or after an agglomeration process. When the organic solvent is removed after the agglomeration process, it is possible to promote fusion and coalition of agglomerated fine particles. The agglomeration process will hereinafter be described.

As for the other processing method for the materials dissolved in organic solvent, it is possible that the emulsified dispersant is sprayed into dry atmosphere so that a water-insoluble organic solvent in the droplets is completely removed to form toner fine particles while an aqueous dispersant is vaporized to be removed. As for the dry atmosphere into which the emulsified dispersions is sprayed, air, nitrogen, carbon dioxide, combustion gas and the like which are heated are used. Especially, various airflows heated up to the boiling point or more of the solvent having highest boiling point among the used solvents are generally used. The desired quality is sufficiently obtained with a short period process using a spray dryer, a belt dryer, a rotary kiln and the like.

The toner particles can be formed by using dispersions in which a lubricant is heated and stirred with a surfactant and a dispersant in an aqueous medium. In this case, the following process is available as an example. That is, wax emulsion made by emulsifying a lubricant is prepared and it is agglomerated together with the colorant dispersions in agglomerating the resin particle.

It is preferable that the charge controlling agent is added at the vicinity of the surface of the toner particles. That is, adding it at the vicinity of the surface of the toner particles effectively gives an electrostatic property to the toner. Furthermore, when the charge controlling agent is added and let the charge controlling agent not exposed on the surface of the toner particles, the fluidity of the toner can be obtained.

As for the concrete method to let the toner contain the charge controlling agent, a method of controlling the amount of the charge controlling agent to the resin particles constituting the toner particles can be given as an example. That is, a method that a large amount of the charge controlling agent is added to the resin particles which is to constitute the vicinity of the surface of the toner, and the resin particles are agglomerated in a manner that the resin particles in which the charge controlling agent is not added forms the surface of the toner particles, and a method that the resin particles containing the charge controlling agent are agglomerated, subsequently the surface of agglomerated particles are covered with a resin component which does not contain the charge controlling agent to be capsules, can be given.

As for the method for adding the charge controlling agent inside the resin particle, it is preferable to knead it with the binder resin and regulate the dispersion size. However, in a case that it is eluted or eliminated from the dispersion phase of solvent phase to aqueous phase when it is emulsified in an aqueous medium, it is also possible that it is added to the aqueous phase and incorporated with the toner in the agglomerating process.

[Agglomeration Method of the Resin Particles]

As for the agglomeration method, when the fine particles are dispersed in water with charged, the following methods and the like can be employed. That is, the particles agglomerate one another or an aqueous polymer is adsorbed to the particles to cause the agglomeration by adding an electrolyte or the like which compresses the electrical double layer; the electrostatic charges on the surfaces of the fine particles are neutralized to cause agglomeration or the counter ion of the adsorbed surfactant and dispersant is changed by adding a compound having an opposite charge from that of the used surfactant and dispersant and; the solubility of the surfactant and dispersant to the aqueous medium is changed so that the dispersion stability thereof is lowered to cause the agglomeration by adding the other material to the aqueous medium.

In this process, the agglomeration can be performed together with the fine resin particles having a polar group and the dispersions of the above-described lubricant, so that the manufactured toner has a release property in the fixing and an improved triboelectric property. Further, fine resin particles having high glass transition point are arranged to be located comparatively outside of the toner so that the blocking of the toner under storage at high temperature is prevented.

As for the flocculant, for examples of an electrolyte, common inorganic or organic water soluble salt represented by sodium sulfate, ammonium sulfate, potassium sulfate, magnesium sulfate, sodium phosphate, sodium dihydrogen phosphate, disodium hydrogen phosphate, ammonium chloride, calcium chloride, cobalt chloride, strontium chloride, cesium chloride, barium chloride, nickel chloride, magnesium chloride, rubidium chloride, sodium chloride, potassium chloride, sodium acetate, ammonium acetate, potassium acetate, sodium benzoate and the like can be used. In a case of a monovalent electrolyte, the concentration of these electrolytes is in a range of preferably 0.01 to 2.0 mol/l, more preferably 0.1 to 1.0 mol/l and particularly preferably 0.2 to 0.8 mol/l. In a case of multivalent electrolyte, the loading amount can be less. As for the compounds which co-exists in aqueous solvent and lowers dispersion stability to cause agglomeration, water-soluble organic compounds such as ethanol, butanol, iso-propanol, ethyl Cellosolve, butyl Cellosolve, dioxane, tetrahydrofuran, acetone, methlethylketone can be used.

Further, it is possible to regulate the shape of the formed toner by heating the dispersions and fusing the fine particles after the agglomeration. The toner is globularized by the interfacial tension thereof. However, the particle shape can be controlled optionally from a globular shape to an amorphous shape according to the heating temperature, viscosity of the toner, presence of organic solvent and the like.

The obtained dispersions of the agglomerated particles can be sprayed into a dry atmosphere so that water-insoluble organic solvent left in the agglomerated particles is removed completely and the toner particles are formed, while the aqueous dispersant can be vaporized and removed. As for the dry atmosphere into which the emulsified dispersions is sprayed, air, nitrogen, carbon dioxide, combustion gas and the like which are heated are used. Especially, various airflows heated up to the boiling point or more of the solvent having highest boiling point among the used solvents are generally used. The desired quality is sufficiently obtained with a short period process using a spray dryer, a belt dryer, a rotary kiln and the like. When a process of solid-liquid separation, adding water and re-dispersion (re-slurry) is performed repeatedly, the used dispersant and emulsifier are virtually removed.

[Acid Value and Hydroxyl Value of the Toner]

As described above, the toner obtained by agglomeration of the resin particles, colorant particles, lubricant particles and the like, possibly has an acid value of less than 20 mgKOH/g, and a hydroxyl value of 7 to 57 mgKOH/g.

As for the measuring method of the acid value and hydroxyl value, a method of JIS0070-1992 can be given as an example. The concrete method thereof is as follows. 2 to 10 g of a sample is measured and put into a 200 to 300 ml Erlenmeyer flask. About 50 ml of a mixed solvent of methanol:toluene=30:70 is added so as to dissolve the resin. When it is not dissolved well, a small amount of acetone can be added or it can be heated up to 40 to 50° C. Subsequently, the solution is titrated with previously measured N/10 potassium hydrate alcohol solution, using 0.1 weight % mixed indicator of bromthymol blue and phenol red, and the acid value is calculated from the used amount of the solution with the following formula.

Acid value=KOH (ml amount)×N×56.1/sample weight (Where N represents a factor of N/10 KOH)

When a sample is the toner powder, resin particles or lubricant, they are measured after being dried to have the moisture content thereof of 1.0% or less. The moisture content is measured by Karl Fischer's method.

Here, resins such as polyester easily absorb water comparatively. Further, the dispersant for dispersing resin particles and the colorant particles, and the flocculant used for agglomerating them in manufacturing a toner also have high absorbability and adsorptivity. Thus, the manufactured toner tends to be moist.

However, this particularly causes high temperature humidity environment dependency of the electrostatic property thereof. As a result, variability of a develop property in image forming increases, and a toner blister is generated in heat fixing of a toner image, which results decrease of an image quality. For the information, toner blister is a phenomenon that when water vaporizes to be gas and leaves from a toner image which is heated up in a heat fixing, the vapor make a pinhole on the toner image, and the toner image where the pinhole generates is failed in an one-dot line image and the like.

Accordingly, it is required in the above manufacturing method of a toner that the acid value and hydroxyl value thereof are lowered to a certain level or less.

[Shape of the Toner]

As described above, the shape of the toner obtained by agglomerating the resin particles, colorant particles, lubricant particles and the like, has the circularity (shape coefficient) thereof of 0.94 to 0.99 on an average and preferably 0.94 to 0.98, where it is represented by the following formula, where 2000 or more pieces of toner particles having the particle diameter thereof of 1 μm or more are measured.
Circularity=(perimeter of the corresponding circle)/(perimeter of toner particle projection image)=2π×(particle projection image area/π)1/2/(perimeter of toner particle projection image)

Where corresponding circle designates a circle having similar area of the toner particle projection image, and corresponding circle size designates diameter of the corresponding circle.

As for the measuring method for the above circularity, it can be measured by FPIA-2000 (made by Sysmex Corp.). Here, corresponding circle size is defined by the following formula.
Corresponding circle size=2x(projection image area of particle/π)^{1/2}

Further, the toner shape is characterized in that the average value of the corresponding circle size is 2.6 to 7.4 μm, slope of the primary correlation between the corresponding circle size and the circularity ((variation of circularity)/(variation of corresponding circle size)) is −0.050 to −0.010. It is more preferable that the average value of the corresponding circle size is 3.4 to 6.6 μm and the slope of the primary correlation between the corresponding circle size and the circularity is −0.040 to −0.020.

The slope of the primary correlation between the corresponding circle size and the circularity is measured as follows. The corresponding circle size and circularity of the toner particle are measured by flow type particle image analyzer FPIA-2000. The relation between the corresponding circle size (μm) and circularity is plotted where the corresponding circle size is a horizontal axis (x axis) and the circularity is a vertical axis (y axis). From the primary correlation (y=αx+b), α=Δy/Δx shows the slope.

From a viewpoint of improving charge uniformity and halftone uniformity, R² (R squared) is preferably 0.35 to 0.95. It is to be noted that R is represented by the following formula (I).
R=A/B Formula (I)

In the above formula, A and B represent the following formulas respectively.
A=nεXY−(εXεY)
B=(nεX²−(εX)²)×((nεY²)−(εY)²)

Where X represents corresponding circle size (μm) and Y represents circularity.

In order to prepare a toner having a slope of a corresponding circle size, slightly larger heteromophic toner particles can be mixed with small circular toner particles. Alternatively, the following method is possible. That is, in manufacturing the toner particles by association of the resin particles, a flocculant is added in the association process, subsequently a shape of stirring propeller is properly selected and the stirring force is controlled so as to be a condition that large particles are easily subject to be under shearing force, and the process is shifted to filtration and drying process. Preferably, the toner manufacturing apparatus is connected with the above described flow type particle analyzer and the slope a is monitored. When a becomes a desired value depending on reaction time, the system is cooled.

When the toner has the property within this ranges, it is possible to obtain a high quality image where a blot of dot is controlled and uniformity of halftone is high.

The reason for the above is suggested as follows. When shape and particle size of a toner are totally uniform, the toner can not fill an image finely. Further, when the toner flies from a photoconductor to a transfer material in transfer, transfer blot easily occurs since the repulsive forces between the toner particles are equal.

[Developer]

The toner obtained by agglomeration of the resin particles, colorant particles, lubricant particles and the like as described above can be used as a single component developer or a double components developer.

As for the single component developer, a nonmagnetic single component developer and a magnetic single component developer containing magnetic particles of 0.1 to 0.5 μm inside the toner can be given, and both of them are available.

The toner obtained by agglomeration of the resin particles, colorant particles, lubricant particles and the like as described above can be used as a double components developer when it is mixed with a carrier of a magnetic particle. As for the carrier, known materials in earlier development can be used. For example, metals such as iron, ferrite and magnetite, alloys of these metals with aluminum, lead and the like can be given. Among them, ferrite particles are preferable. As for the volume average particle size of the above carrier, 15 to 100 μm is preferable and 25 to 80 μm is more preferable.

The volume average particle size of the carrier can be measured by laser diffraction type particle size analyzer “Helos” (made by Sympatic Corp.).

Furthermore, as for the carrier, a carrier in which a magnetic particle is coated with resin and so-called resin dispersed carrier in which magnetic particles are dispersed in a resin can be used. As for the resin for the coating, for example, olefin series resin, styrene series resin, styrene-acryl series resin, silicone series resin, ester series resin, fluorine containing polymer series resin and the like can be given. As for the resin constituting the resin dispersed carrier, for example, styrene-acryl series resin, fluorine series resin polyester resin, phenol resin and the like can be given.

[Method for Forming Fixed Image]

Next, an image forming method by the use of the toner obtained by agglomeration of the resin particles, colorant particles, lubricant particles and the like will be explained. In this image forming method, an image is formed with an image forming apparatus. Thus, the image forming method will be explained first.

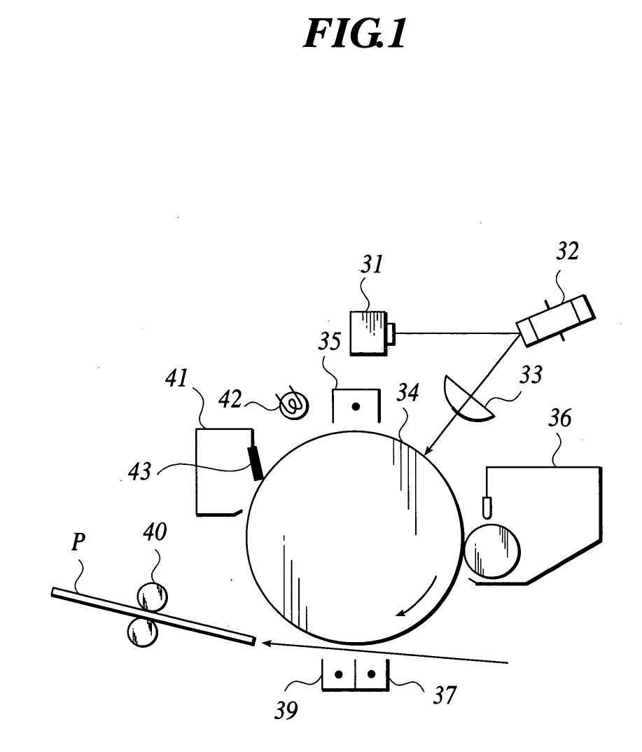

FIG. 1 is a constitutional view showing one of examples of the image forming apparatus. The reference numeral 34 designates a photoconductor drum which is a body to be charged, in which an organic photoconductor (OPC) of the photoconductive layer is formed on an external surface of an aluminum base drum and the drum rotates in a direction of the arrow at a predetermined velocity.

In FIG. 1, a semiconductor laser source 31 emits an exposure light based on information read by a document reading device not illustrated. The light is divided by a polygon mirror 32 to the direction perpendicular to the sheet plane of FIG. 1, and irradiates via fθ lens 33 correcting a distortion of an image onto a photo conductor plane to form an electrostatic latent image. The photoconductor drum 34 is previously charged uniformly with an electrostatic charger 35 and has started the rotation thereof in a clockwise direction along with the timing of an image exposure.

An electrostatic latent image on the photoconductor drum is developed with a developer 36, and the developed image is transferred by an operation of a transfer device 37 to a recording material P (also referred to as a transfer material, a transfer paper and a recording paper) which has conveyed timely. A transfer material 38 is separated from the photoconductor drum 34 by a separator (separating pole) 39. The developed image is transferred and kept on the transfer material 38 and is introduced to a fixer 40 to be fixed.

Un-transferred residual toner or the like left on the photoconductor surface is cleaned with a cleaner 41 of cleaning blade type. The residual charge is removed by a pre-charge exposure (PCL) 42 and the photoconductor is charged uniformly with the electrostatic charger 35 in preparation for the next image forming.

It is particularly preferable that the exposure is digital image exposure, and can be an exposure by analogue method.

The toner can be applied to an image forming apparatus by electrophotography, especially an apparatus where an electrostatic latent image is formed on a photoconductor with a modulated beam which is modulated according to a digital image data form an computer or the like.

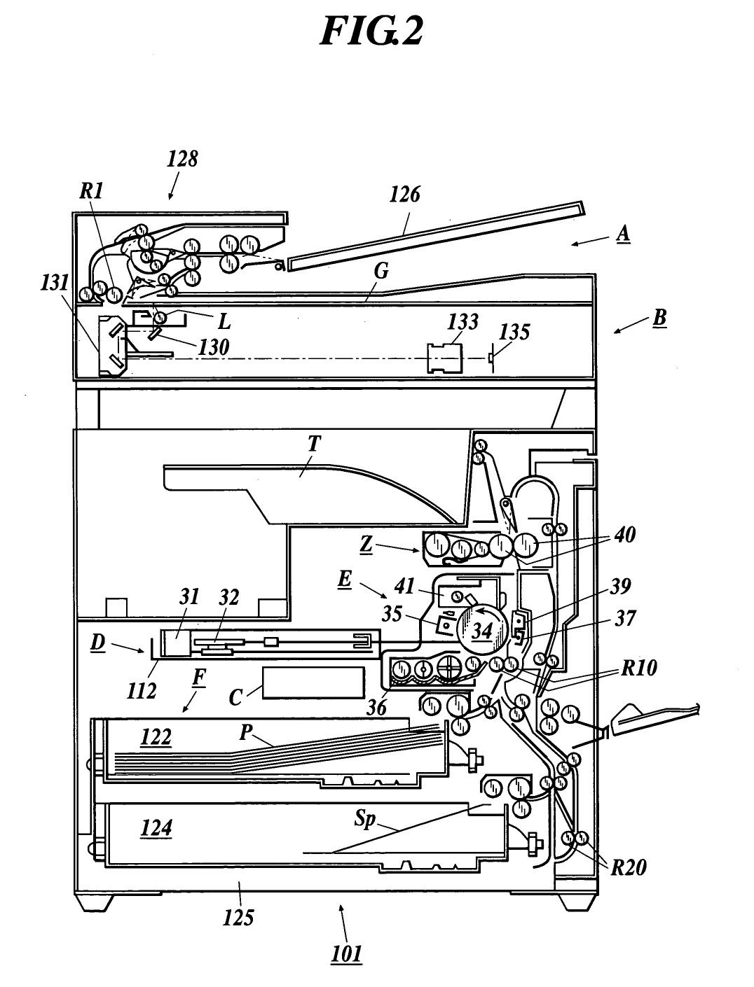

FIG. 2 is a constitutional section view showing a digital image forming apparatus applied to the toner.

In FIG. 2, an image forming apparatus 101 comprises an automatic document feeder (commonly known as ADF) A, a document image reading part B to read an image of a document conveyed by the automatic document feeder, an image controller board C to process the read document image, a writing part D including a writing unit 112 to perform a writing onto the photoconductor drum 34 as an image keeper according to the image processed data, an image forming part E including the photoconductor drum 34 and image forming members placed around the photoconductor drum 34 such as the electrostatic charger 35, the developer 36 made up of a magnetic blush type developing device, transfer device 37, separator 39, cleaner 41 and the like, and housing part F comprising a feeder trays 122 and 124 to house the recording paper P.

The main component of the automatic document feeder A is a document conveying and processing part 128 comprising a document mounting base 126, a roller group including a roller R1, a switching member to switch a carrying path of a document properly and the like (no reference numerals) The document image reading part B is located below a platen glass G and is composed of two mirror units 130 and 131 which can reciprocate with keeping the optical path length, a fixed imaging lens (hereinafter, simply referred to as a lens) 133, a linear imaging element (hereinafter, referred to as CCD) 135 and the like. The writing part D is composed of a laser source 31, a polygon mirror (polarizer) 32 and the like.

R10 shown at front side of the transfer device 37, when it is observed from the moving direction of the recording paper P as a transfer material, is a resist roller, the one labeled 40 located at downstream side of the separator 39 is a fixing device.

In the embodiment, the fixing device 40 is composed of a roller having a heat source and a press roller rotating while pressing and contacting with the roller

Z designates a cleaning member of the fixing device 40, and the main component thereof is a cleaning web provided to be windable.

A sheet of documents (not illustrated) mounted on the document mounting base 126 is conveyed by the document conveying and processing part 128, and an exposure by an exposure member L is performed while the document passes through under the roller R1.

The reflected light from the document is imaged on the CCD 135 through the mirror unit 130 and 131 located at fixed positions and the lens 133, and is read.

The image information read on the document image reading part B is processed to be encoded by an image processing member and is memorized in a memory provided on the image control board C.

The image data is called up responsive to the image forming, and the laser light source 31 of the writing part D is activated according to the image data so that an exposure is performed on the photoconductor drum 34.

Recently, in the fields such as an electrophotograph in which an electrostatic latent image is formed on a photoconductor and a visible image is obtained by developing the latent image, research and development on an image forming method employing a digital system which can easily improve, convert and edit image quality and can form a high quality image has been increasing.

As for the scanning optical system applied to the image forming method and apparatus, whose light is modulated according to a digital image signal from a computer applied to this image forming method and apparatus or a copy document, an apparatus where an acoustooptical modulator is provided with the laser light system and it performs a light modulation, and an apparatus where a semiconductor laser is used and laser intensity is directly modulated can be given. A dot image is formed by performing a spot exposure from these optical systems onto the uniformly charged photoconductor.

The beam irradiated from the above-described scanning optical system has circular or elliptic luminance distribution in which its bottom spreads to both sides. For example, in a case of a laser beam, it is generally an extremely small circular or elliptic spot whose size is 20 to 10 μm on the photoconductor in both or either main scanning direction and/or sub scanning direction.

The image forming method by the use of the toner is applied not only to an image forming of a monochrome image but also to an image forming of a color image. For example, it is an image forming method in which a plurality of image forming units are provided and each of the image forming units forms a visible image (toner images) of different color respectively, so that a toner image is formed.

The toner is suitably used in an image forming method comprising a process that an image forming support where a toner image has formed is fixed by getting the support through between a heating roller and a pressing roller constituting the fixing device.

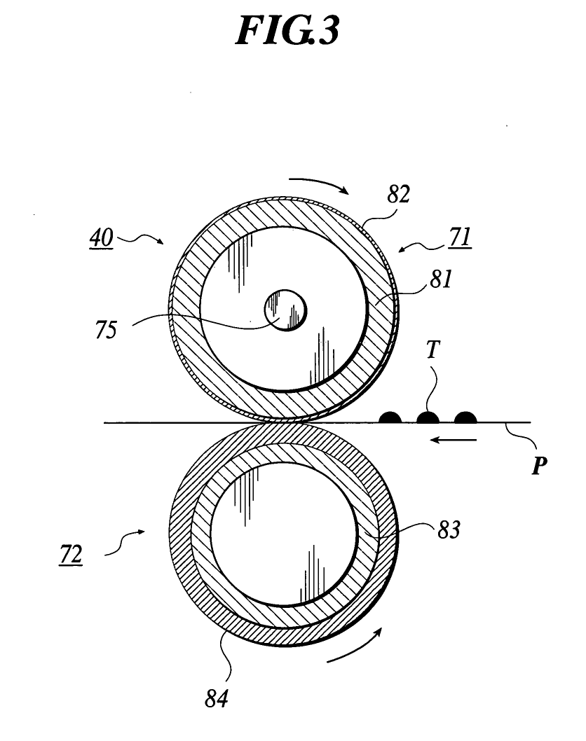

FIG. 3 is a section view showing one example of the fixing device used in the image forming method by the use of the toner. The heating roller 71 and a pressing roller 72 which contacts with the heating roller 71 are provided with the fixing device 40 shown in FIG. 3. In FIG. 3, T is a toner image formed on the recording material P.

The heating roller 71 comprises a coating layer 82 made of a fluorine resin or a elastic body and a core metal 81 in which a coating layer 82 is formed on the surface of a core metal 81, and further comprises a heating member 75 inside thereof, which is made of a linear heater.

The core metal 81 is composed of metal, and the inner diameter thereof is 10 to 70 mm. As for the metal constituting the core metal 81, which is not especially limited, metals such as iron, aluminum and copper and the alloys thereof can be given.

The thickness of the core metal is 0.1 to 15 mm and is decided according to a balance of an energy saving (to be thin) and the strength thereof (depending on the material). For example, when similar strength of a core metal made of iron having 0.57 mm thickness is required for a core metal made of aluminum, its thickness is need to be 0.8 mm.

As for the fluorocarbon polymer constituting the coating layer 82, PTFE (polytetrafluoroethylene), PFA (tetrafluoroethylene-perfluoroalkyl vinylether copolymer) and the like can be given as examples.

The thickness of the coating layer 82 made of fluorocarbon polymer is 10 to 500 μm and preferably 20 to 400 μm.

As for the heating member 75, a halogen heater can be suitably applied.

The pressing roller 72 is made where a coating layer 84 made of an elastic body is formed onto a surface of core metal 83. As for the elastic body constituting the coating layer 84, which is not especially limited, various soft rubbers such as a urethane rubber and a silicone rubber and a sponge rubber can be given. The exemplified silicone rubber and silicone sponge rubber are preferably used as the coating layer 84.

The Asker C hardness of the elastic body constituting the coating layer 84 is less than 80°, preferably less than 70°, and more preferably less than 60°.

The thickness of the coating layer 84 is 0.1 to 30 mm preferably 0.1 to 20 mm.

As for the material of the core metal 83, which is not limited especially, metals such as aluminum, iron and copper and the alloys thereof can be given.

The contact load (total load) between the heating roller 71 and the pressing roller 72 is generally 40 to 350 N, preferably 50 to 300 N and more preferably 50 to 250 N. This contact load is decided in view of the strength of the heating roller 71 (thickness of the core metal 81). When a heating roller has an iron core metal of 0.3 mm thickness as an example, it is preferably 250 N or less.

From a viewpoint of resistance to offset property and fixing property, a nip width is preferably 4 to 10 mm and the contact pressure of the nip is preferably 0.6×10⁵ Pa to 1.5×10⁵ Pa.

One of examples of the fixing condition for the fixing device shown in FIG. 3 is a fixing temperature (surface temperature of the heating roller 71) of 150 to 210° C. and fixing linear velocity of 230 to 900 mm/sec.

A cleaning system can be attached to the above-described fixing device. As for the cleaning method, a method that various silicone oils are supplied to a fixing film and a method that the fixing device is cleaned with a pad, roller, web or the like impregnated with various silicone oils.

As for the silicone oil, polydimethylsiloxane, polymethylphenylsiloxane, polydiphenylsiloxane and the like can be used. Further, fluorine containing siloxane can be suitably used.

Note that the above explains a method using a fixing roller (heating roller), which is a representative method for fixing the toner. However, the toner can be applied to any method in which a transfer paper is heated by contact heating, such as a method using a fixing belt (heating belt).

### Embodiment

Hereinafter, the invention will be explained with referring embodiments. However, the present invention is not limited to the following embodiments. In the following description, “part(s)” designates part(s) by mass, and “%” designates mass %.

[Preparation of the Color Toner]

Into a reaction container having a cooling pipe, a stirrer and a nitrogen introducing pipe, 343 parts of 2 mol ethylene oxide adduct of bisphenol A, 166 parts of isophthalic acid and 2 parts of dibutyltin oxide were placed. The mixture were reacted at 230° C. for 8 hours under ordinary pressure, further reacted for 5 hours under reduced pressure of 10 to 15 mmHg (1.33 to 1.99 Pa), and cooled to 110° C. 17 parts of isophorone diisocyanate was added and reacted in toluene for 5 hours at 110° C.

Next, desolvating was performed so as to obtain [urethane denatured polyester (1)] having a weight average molecular weight of 72,000 and free isocyanate content of 0.7%. In a similar way as described above, 570 parts of 2 mol ethylene oxide adduct of bisphenol A and 217 parts of terephthalic acid were polycondensed each other at 230° C. for 6 hours under ordinary pressure so as to obtain a non-denatured [polyester (2)] having a number average molecular weight of 2,400, a hydroxyl value of 51 and an acid value of 5. 200 parts of the [urethane denatured polyester (1)] and 800 parts of the [polyester (2)] were dissolved into 2000 parts of ethyl acetate and mixed so as to obtain a resin solution 1. The resin component in the resin solution 1 has Tg of 64° C., acid value of 5 mgKOH/g and hydroxyl value of 14 mgKOH/g.

(Manufacturing Example of the Toner)

| | | |
|---|---|---|
| resin solution 1 (Tg of the resin | 100 | parts |
| component is 64° C.) | | |
| pigment Blue 15:3 (wet cake) | 12 | parts |
| (solid content in the wet cake is 50%) | | |
| charge controlling agent | 1 | part |
| (Spirone Black TRH, made by | | |
| Hodogaya Chemical Co., Ltd.) | | |
| carnauba wax (acid value: 5 mgKOH/g) | 10 | parts |

The above materials were dissolved and dispersed in 200 part of toluene by rotating a ball mill filled with zirconia beads, so that oil phase of the dispersion phase is prepared.

On the other hand,

| | | |
|---|---|---|
| ion-exchanged water | 700 | parts, and |
| sodium dodecylbenzene sulfonate | 1 | parts |

were stirred to be dispersed, so that aqueous phase to be the continuation phase was prepared. The oil phase was put into the aqueous phase while stirring with a homomixier (Tokusyukikakogyo Co., Ltd.), so that oil droplets having a volume mean particle size of 1 μm is prepared by regulating the stirring frequency. Subsequently, toluene was removed by vacuum drying at 50° C., to obtain a pale blue emulsion.

The dispersions is carried to a stirring tank having an impeller, and the aqueous solution where 10 parts of aluminum sulfate is dissolved to 90 parts of ion-exchanged water was gradually dripped to the dispersions while stirring slowly, so that agglomerates are formed. Subsequently, the dispersions were kept at 70° C. and the fusion of the agglomerates are checked by sampling a part of the fused agglomerates and observed it under a scanning electron microscope.

Subsequently, the dispersions were stirred for 8 hours at 95° C. When a circularity of the colored particles became 0.96, the dispersions were cooled to 40° C. and the stirring was stopped. It is to be noted here that the measured properties such as circularity do not change by adding the following external additive and the like to be the toner.

The dispersions were washed with water and filtrated repeatedly. The obtained cake was dried under vacuum condition to obtain cyan color particles. 100 parts of the obtained color particles, 0.8 part of needlelike titanium oxide (the major axis of 120 nm, n-decylmethoxysilane treated), 1.8 parts of globular monodisperse silica (silica sol obtained by a sol-gel method is subject to a hexamethyldisilane treatment, and was dried and grinded, particle size of 137 nm), 0.3 parts of silica particles manufactured by a vapor phase method and treated with octylmethoxysilane (particle size 14 nm) were mixed with a Henschel mixer, and were passed through a sieve having the pore size of 50 μm to remove course particles and agglomerates, so that toner C-1 for forming electrostatic latent image was obtained.

Preparation of the Other Toners

In a similar way as described above, except pigment blue 15:3 (wet cake) was substituted with a wet cake of carbon black, black toner (B-1) was prepared.

Preparation of Toner (C-2)

The preparation method of toner (C-2) was a similar process of preparation method of toner (C-1), except terephthalic acid and trimellitic acid of the polyester (2) were 200 parts and 17 parts respectively. The resin component has Tg of 64° C., the acid value of 17 mgKOH/g and the hydroxyl value of 18 mgKOH/g.

Preparation of Toner (C-3)

The preparation method of toner (C-3) was a similar process of preparation method of toner (C-2), except the acid value of the carnauba wax was 4 mgKOH/g.

Preparation of Toner (C-4)

The preparation method of toner (C-4) was a similar process of preparation method of toner (C-1), except terephthalic acid and trimellitic acid of the polyester (2) were 177 parts and 40 parts respectively. The resin component has Tg of 64° C., the acid value of 25 mgKOH/g.

Preparation of Toner (C-5)

While the reaction time of the polyester (2) is 6 hours in the preparation of toner (C-4), the reaction time of the polyester (2) was 8 hours in the preparation of toner (C-5). Except for the above, the preparation method of toner (C-5) was a similar process of preparation method of toner (C-4). The resin component has Tg of 64° C., the acid value of 22 mgKOH/g and the hydroxyl value of 30 mgKOH/g.

Preparation of Toner (C-6)

The preparation method of toner (C-6) was a similar process of preparation method of toner (C-1), except terephthalic acid, trimellitic acid and the reaction time of the polyester (2) were 203 parts, 14 parts and 3 hours respectively.

Preparation of Toner (C-7)

The preparation method of toner (C-7) was a similar process of preparation method of toner (C-4), except the reaction time of the polyester (2) was 3 hours. The resin component has Tg of 64° C., acid value of 25 mgKOH/g and hydroxyl value of 60 mgKOH/g.

Preparation of Toner (B-1)

While 12 parts of Pigment Blue 15:3 was used in the preparation of toner (C-1), 10 parts of carbon black (Regal 660R, made by Cabot, corp.) was used in the preparation of toner (B-1). While the reaction time of the polyester (2) was 6 hours in the preparation of toner (C-1), the reaction time of the polyester (2) was 4 hours in the preparation of toner (B-1). Except for the above, the preparation method of toner (B-1) was a similar process of preparation method of toner (C-1). The resin component has Tg of 64° C., the acid value of 5 mgKOH/g and the hydroxyl value of 40 mgKOH/g.

Preparation of Toner (B-2)

While 12 parts of Pigment Blue 15:3 was used in the preparation of toner (C-2), 10 parts of carbon black (Regal 660R, made by Cabot, corp.) was used in the preparation of toner (B-2). While the reaction time of the polyester (2) was 6 hours in the preparation of toner (C-2), the reaction time of the polyester (2) was 4 hours in the preparation of toner (B-2). Except for the above, the preparation method of toner (B-2) was a similar process of preparation method of toner (C-2). The resin component has Tg of 64° C., acid value of 18 mgKOH/g and hydroxyl value of 40 mgKOH/g.

Preparation of Toner (B-3)

While 12 parts of Pigment Blue 15:3 was used in the preparation of toner (C-3), 10 parts of carbon black (Regal 660R, made by Cabot, corp.) was used in the preparation of toner (B-3). While the reaction time of the polyester (2) was 6 hours in the preparation of toner (C-3), the reaction time of the polyester (2) was 4 hours in the preparation of toner (B-3). Except for the above, the preparation method of toner (B-3) was a similar process of preparation method of toner (C-3). The resin component has Tg of 64° C., acid value of 18 mgKOH/g and hydroxyl value of 40 mgKOH/g.

Preparation of Toner (B-4)

The preparation method of toner (B-4) was a similar process of preparation method of toner (C-4) except 10 parts of carbon black (Regal 660R, made by Cabot, corp.) was used in the preparation of toner (B-4) While 12 parts of Pigment Blue 15:3 was used in the preparation of toner (C-4). The resin component has Tg of 64° C., acid value of 25 mgKOH/g and hydroxyl value of 40 mgKOH/g.

Preparation of Toner (B-5)

The preparation method of toner (B-5) was a similar process of preparation method of toner (C-5) except 10 parts of carbon black (Regal 660R, made by Cabot, corp.) was used in the preparation of toner (B-5) While 12 parts of Pigment Blue 15:3 was used in the preparation of toner (C-5). The resin component has Tg of 64° C., acid value of 22 mgKOH/g and hydroxyl value of 30 mgKOH/g.

Preparation of Toner (B-6)

The preparation method of toner (B-6) was a similar process of preparation method of toner (C-6) except 10 parts of carbon black (Regal 660R, made by Cabot, corp.) was used in the preparation of toner (B-6) While 12 parts of Pigment Blue 15:3 was used in the preparation of toner (C-6). The resin component has Tg of 64° C., acid value of 16 mgKOH/g and hydroxyl value of 59 mgKOH/g.

Preparation of Toner (B-7)

The preparation method of toner (B-7) was a similar process of preparation method of toner (C-7) except 10 parts of carbon black (Regal 660R, made by Cabot, corp.) was used in the preparation of toner (B-7) While 12 parts of Pigment Blue 15:3 was used in the preparation of toner (C-7) . The resin component has Tg of 64° C., acid value of 25 mgKOH/g and hydroxyl value of 59 mgKOH/g.

TABLE 1

| | | | | AVERAGE | |
|---|---|---|---|---|---|
| | | ACID | HYDROXYL | VALUE OF | |
| | | VALUE | VALUE | CIRCULAR- | |
| | TONER | (mgKOH/g) | (mgKOH/g) | ITY (μm) | SLOPE |
| (1) | C-1 | 5 | 14 | 0.962 | −0.034 |
| (2) | C-2 | 17 | 18 | 0.961 | −0.036 |
| (3) | C-3 | 17* | 18 | 0.968 | −0.038 |
| (4) | C-4 | 25 | 40 | 0.952 | −0.047 |
| (5) | C-5 | 22 | 30 | 0.931 | −0.054 |
| (6) | C-6 | 15 | 60 | 0.964 | −0.028 |
| (7) | C-7 | 25 | 60 | 0.938 | −0.062 |
| (8) | B-1 | 5 | 40 | 0.981 | −0.019 |
| (9) | B-2 | 18 | 40 | 0.987 | −0.014 |
| (10) | B-3 | 18* | 40 | 0.982 | −0.012 |
| (11) | B-4 | 25 | 40 | 0.991 | −0.008 |
| (12) | B-5 | 22 | 30 | 0.992 | −0.001 |
| (13) | B-6 | 16 | 59 | 0.994 | +0.001 |
| (14) | B-7 | 25 | 59 | 0.991 | −0.004 |

*Lubricant having an acid value of 4 mgKOH/g was used.

[Evaluation Method]

Each toner was mixed with the following carrier, so that developers of C-1 to B-7 corresponding to the toners respectively were prepared.

(Preparation of the Carrier)

| | | |
|---|---|---|
| silicone resin (20%) | 100 | parts |
| γ-(2-aminoethyl) aminopropyl | 1.0 | parts |
| trimethoxy silane | | |
| carbon black | 0.1 | parts |
| toluene | 60 | parts |

The above materials were dispersed with homomixer for 20 minutes, so that a covering layer forming solution was prepared. The solution was mixed with 1000 parts of ferrite (volume average particle size of 55 μm, saturation magnetization of 9.0×10⁻⁵ Wb·m/kg), and a covering layer was formed on the surface of the ferrite by using a coating equipment of flowing base type. Then, it was fired in an electric furnace to be the carrier.

(Preparation of the Developer)

100 parts of the carrier and 5 parts of each of the color toners were mixed for 15 minutes at 50 ppm with a tabular mixer of the type that a container rotates for stirring and charged, so that the developer was prepared.

An image forming was carried out by using an image forming apparatus having similar constitution of that shown in FIG. 1 and the above developer, so as to perform an evaluation of the developer.

[Evaluation Item]

1. Fixing Property

Fixing Property for a Board Paper

The following tests were carried in order to evaluate a fixing ratio (solid image) as a fixing property in a case that an image is formed on a thick paper used for a large-sized office envelope.

The fixing ratio of the obtained fixed image was measured and evaluated by the method based on an adhesive tape peeling method described in chapter 9, section 1.4 of “basis and application of electrophotographic technology, edited by society of electrophotography”.

Concretely, a fixed solid image of 2.54 cm square in which a toner amount was 0.6 mg/cm² was prepared. The image densities thereof before and after peeling with an Scotch mending tape (made by Sumitomo 3M) were measured and the residual ratio of the image density was obtained to be the fixing ratio. Macbeth reflection densitometry RD-918 was used for measuring the image density. The fixing ratio of 95% or more was discriminated as an acceptance, and was denoted as “A”. The fixing ratio of less than 95% was denoted as “D”.

Fixing Ratio of Halftone Image

The evaluation was carried out in a similar way of the above fixing ratio evaluation of a solid image, except a halftone fixed image of 2.54 cm square in which a toner amount was 0.3 mg/cm² was prepared.

By the above test, it was evaluated whether a gray halftone image can be fixed certainly, or not.

2. Electrostatic Property of the Toner and Image Stability Against an Environment

In order to evaluate the electrostatic property of the toner and an image stability of a first and 20,000th formed images, a difference of the images according to a charge variation of the toner is evaluated between a high temperature and high humidity environment (HH, 30° C., 80% RH) and a low temperature and low humidity environment (LL, 10° C., 20% RH)

The electrostatic potential of the toner was evaluated from the value thereof and the image quality was evaluated from printed charts of continuous gradation image and non-gradation fine image according to the following criteria.

A: Both of the properties are fine.

B: Break and distortion of the fine image and unevenness of density at intermediate density part of the graduation image are seen a little, but allowable in a practical use.

D: Break and distortion of fine image and unevenness of density at intermediate density part of the graduation image are seen a little, and problematic in a practical use.

3. Density of 10% Mesh

Relative image density of 10% mesh image part of 20 mm×20 mm is measured with respect to a blank part by using Macbeth reflection densitometer “RD-918”. The evaluation of 10% mesh density was carried out in order to evaluate reproducibility of dot and halftone. When the density variation was 0.10 or less, it can be said that the quality variation is small and of no matter, and it was denoted as “A”. When the density variation was more than this, it was denoted as “D”.

4. Line Width

Line width of a line image corresponding to an image signal of 2 dots line was measured by printing evaluation system “RT2000” (made by Ya-Man, Ltd). It was considered that the line width reproducibility is of no matter when line width of a first and 20,000th formed images are both 200 μm or less and the variation of the line width is less than 10 μm. It was denoted as “A” and the other was denoted as “D”.

5. Toner Blister

An occurrence of toner blister in a high density uniform image and an image of arranged one-dot lines, which was prepared under high temperature and high humidity environment (HH, 30° C., 80% RH) was checked.

The image was checked with the naked eyes and under a loupe. The image in which a toner blister is hardly detected was denoted as “A”, one in which a toner blister is slightly generated but unnoticeable without paying close attention was denoted as “B”, and one in which a toner blister is detected was denoted as “D”.

[Evaluation Result]

The above results were shown in Table. 2.

TABLE 2

| | | | | IMAGE QUALITY | | | |
|---|---|---|---|---|---|---|---|
| | | | | STABILITY | | | |
| | | FIXING PROPERTY | | ACCORDING TO | DENSITY OF | LINE | TONER |
| | TONER | HEAVY PAPER | HALFTONE | HUMIDITY | 10% MESH | WIDTH | BLISTER |
| (1) | C-1 | A | A | A | A | A | A |
| (2) | C-2 | A | A | B | A | A | A |
| (3) | C-3 | A | A | B | A | A | A |
| (4) | C-4 | A | A | D | D | D | D |
| (5) | C-5 | A | A | D | D | D | D |
| (6) | C-6 | A | A | D | D | D | D |
| (7) | C-7 | A | A | D | D | D | D |
| (8) | B-1 | A | A | B | A | A | A |
| (9) | B-2 | A | A | B | A | A | B |
| (10) | B-3 | A | A | B | A | A | B |
| (11) | B-4 | A | A | D | D | D | D |
| (12) | B-5 | A | A | D | D | D | D |
| (13) | B-6 | A | A | D | D | D | D |
| (14) | B-7 | A | A | D | D | D | D |

The images in which the toners for developer C-1, C-2, C-3, B-1, B-2 and B-3 were used were fine in all properties, but the images in which the toners for developer C-4, C-5, C-6, C-7, B-4, B-5, B-6 and B-7 were problematic in at least any one of properties.

That is, it is possible to provide the toner for developing electrostatic latent image and the image forming method by use thereof, in which image quality is fine, toner blister is not generated, temperature and humidity environment in image forming does not affect the image quality, and it can always fulfill client's request. Further, it is possible to provide the toner in which the toner image thereof formed on a printing paper can have a slipping property and a fixing property comparable to that of printed matters in earlier development.

The entire disclosure of Japanese Patent Applications No. 2003-061198 filed on Mar. 7, 2003, including specification, claims, drawings and summary is incorporated herein by reference in its entirety.

What is claimed is:

1. A toner for electrostatic latent image development,
wherein the toner is made by agglomeration of a resin particle and a colorant particle in an aqueous medium, an acid value of the toner is less than 20 mgKOH/g, and a hydroxyl value of the toner is 7 to 57 mgKOH/g.

2. The toner of claim 1, wherein circularity of the toner is 0.94 to 0.99 on an average, a corresponding circle size of the toner is 2.6 to 7.4 μm on an average, and a slope of an primary correlation between the circularity and the corresponding circle size is −0.050 to −0.010.

3. The toner of claim 1, wherein a fine particle of silica or a fine particle containing titanium element, each having an average primary particle size of 50 to 200 nm is externally added to the toner.

4. An image forming method comprising: developing a latent image on a photoconductor by the toner of claim 1.

5. A toner for electrostatic latent image development,
wherein the toner is made by agglomeration of a resin particle having an acid value of less than 20 mgKOH/g and a hydroxyl value of 7 to 57 mgKOH/g and a lubricant particle having an acid value of less than 5 mgKOH/g in an aqueous medium.

6. The toner of claim 5, wherein circularity of the toner is 0.94 to 0.99 on an average, a corresponding circle size of the toner is 2.6 to 7.4 μm on an average, and a slope of the circularity with respect to the corresponding circle size is −0.050 to −0.010.

7. The toner of claim 5, wherein a fine particle of silica or a fine particle containing titanium element, each having an average primary particle size of 50 to 200 nm is externally added to the toner.

8. An image forming method comprising: developing a latent image on a photoconductor by the toner of claim 5.
